(19) United States
(12) Patent Application Publication
(10) Pub. No.: US 2021/0230814 A1
(43) Pub. Date: Jul. 29, 2021

(54) ARTIFICIAL TURF SYSTEM INCLUDING TWO ELASTIC LAYERS AND A GEOGRID

(71) Applicants: APT Advanced Polymer Technology Corp., Harmony, PA (US); Polytex Sportbelage Produktions-GmbH, Grefrath (DE)

(72) Inventors: Stephan SICK, Willich-Neersen (DE); Kris BROWN, Dalton, GA (US); Ivo LOHR, Kempen (DE); Stefan HALLY, Nettetal (DE)

(73) Assignees: APT Advanced Polymer Technology Corp., Harmony, PA (US); Polytex Sportbelage Produktions-GmbH, Grefrath (DE)

(21) Appl. No.: 16/751,486

(22) Filed: Jan. 24, 2020

(51) Int. Cl. E01C 13/08

(52) U.S. Cl. CPC E01C 13/083; B32B 25/02

(57) ABSTRACT

An artificial turf system (100, 500) comprises an artificial turf layer (102), an upper elastic layer (104) positioned below the artificial turf layer, and a geogrid (106). The geogrid is positioned between the first elastic layer and a lower elastic layer. The lower elastic layer (108) is positioned below the geogrid.

### FIELD OF THE INVENTION

Certain embodiments of the invention relate to the field of artificial turf systems and methods of manufacture. More specifically, certain embodiments of the invention relate to an artificial turf system that is robust against impact forces even if installed on holey substrates.

### BACKGROUND OF THE INVENTION

Artificial turf or artificial grass is surface that is made up of fibers and used to replace real grass. The structure of the artificial turf is designed such that the artificial turf has an appearance that resembles grass. Typically, artificial turf is used as a surface for sports such as soccer, football, rugby, tennis, and golf, and for playing or exercise fields. Furthermore, artificial turf is frequently used for landscaping applications. An advantage of using artificial turf is that it eliminates the need to care for a grass playing or landscaping surface, for example, with regular mowing, scarifying, fertilizing, and watering. For example, watering can be difficult due to regional restrictions for water usage. In other climatic zones, the regrowing of grass and re-formation of a closed grass cover is slow compared with the rate of damaging the natural grass surface by playing and/or exercising on the field.

Although artificial turf fields do not require as much attention or effort to maintain, they typically exhibit wear after five to 15 years. Mechanical damage from use and exposure to UV radiation, thermal cycling, interactions with chemicals, and various environmental conditions generate wear on artificial turf. It is therefore beneficial, both economically and environmentally, to use an existing worn artificial turf as a base for manufacturing a new artificial turf system.

Artificial turf may be manufactured using techniques for manufacturing carpets. For example, artificial turf fibers, which have the appearance of grass blades, may be tufted or otherwise integrated into a carrier. Often, artificial turf infill is placed between the artificial turf fibers. Artificial turf infill is a granular material that covers the lower portion of the artificial turf fibers.

Sometimes, artificial turf is perceived as being insufficiently “bouncy” if the elasticity of the artificial turf is not sufficient to allow a ball to bounce back quickly. Moreover, artificial turf is sometimes perceived as insufficiently elastic to effectively protect the joints of the players from injury. Hence, the artificial turf is sometimes installed on top of an elastic layer. For example, US 2006/0084513 A1 (De Vries et al.) discloses a method for laying a playing field comprising a layer of a resilient and/or damping material and a top layer arranged on the resilient layer. The top layer may be a synthetic turf.

International patent application WO 2009/118388 A1 describes the forming of an elastic layer (e-layer) by mixing polymer granules with a polyurethane binder.

### BRIEF SUMMARY OF THE INVENTION

Various embodiments provide an artificial turf system and a method for manufacturing an artificial turf system as described by the subject matter of the independent claims. Advantageous embodiments are described in the dependent claims. Embodiments of the present invention can be freely combined with each other if they are not mutually exclusive.

In one aspect, the invention relates to an artificial turf system comprising an artificial turf layer, an upper elastic layer positioned below the artificial turf layer, a geogrid positioned between the first elastic layer and a lower elastic layer, and the lower elastic layer. The lower elastic layer is positioned below the geogrid.

An artificial turf system installed on top of a “sandwich structure” of two elastic layers (“e-layers”) and a geogrid may be advantageous, because the geogrid may ensure that any impacting force is homogeneously distributed across a large surface area. For example, the force of the impact of a ball or the force of a player's foot during sudden braking or change of direction is distributed by the geogrid over a comparatively large area. This reduces the wear and tear of the artificial turf, protects the players from injuries, and improves the movement behavior of the ball.

The use of a geogrid may allow reinforcing of the artificial turf layer and any other, optional layers contained in the artificial turf system. It may prevent the artificial turf layer from being pulled apart under tension. Compared to artificial turf, but also compared to many forms of soil such as sand or clay, geogrids are strong in tension. This fact allows them to transfer forces to a larger area than would otherwise be the case.

It has been observed that the use of the artificial turf system specified above is particularly advantageous in cool climate zones where many freeze-thaw cycles occur every year. This is because the frequent freeze-thaw cycles damage the stone substrate onto which the artificial turf is placed. Larger cracks and holes are created by water that has managed to penetrate the base layer, because when water freezes to ice, it has a larger volume and may thus burst even concrete or stone over the years. If a ball hits artificial turf that has been laid on an uneven base layer with larger cracks or holes, or if the base layer has aged over many years after the artificial turf has been installed at the use site, the ball can damage the artificial turf at places that lie above such a hole. With the placement of the artificial turf on top of a geogrid that distributes impacting forces, this damage can be prevented, because the geogrid has a high tensile strength and significantly reduces the force per square centimeter that actually reaches the base layer (or that has to be fully compensated by the artificial turf layer in case the force is applied at a spot covering a deep hole in the base layer). Thereby, the risk of damaging the artificial turf if the force is applied on an artificial turf area that covers a large crack or hole is significantly reduced.

Embedding the geogrid in two e-layers has been observed to be particularly advantageous, as the e-layers protect the players from injuries that could occur in case a player hits an artificial turf layer that is installed directly on top of a geogrid. The ribs of the geogrid may represent a risk of injury, because the high mechanical rigidity of the geogrid, which should ensure a wide distribution of impact forces, can lead to considerable injuries of the skin and joints when a player hits the ground. A particularly high layer of infill material could partially compensate for these disadvantages. However, high infill layers can have some disadvantages. First, a high infill content changes the ball roll characteristics, making a high infill content unsuitable for some sports. In addition, the acquisition costs of the artificial turf and the maintenance costs can be increased as a result. By embedding the geogrid within two e-layers and placing the artificial turf layer on top of the upper e-layer, injuries may be prevented. Hence, the artificial turf system structure described above may increase the life of artificial turf and prevent injuries to the players by providing an artificial turf system with increased tensile strength and improved distribution of impact forces that is at the same time sufficiently elastic to prevent skin and joint injuries in case a player should hit the ground directly on top of a rib of the geogrid.

Embedding a geogrid between two e-layers may be particularly advantageous, because a stack of two e-layers alone may be too elastic and soft and thus may constitute a biomechanical drawback for the players and/or may make the players tired due to a high level of dampening. The geogrid may distribute mechanical forces imposed, e.g., by a ball or by players of a soccer or rugby game over a large area of the underlying existing artificial turf that is underneath the new artificial turf. Thus, the rigidity of the geogrid provides at least some level of compensation for the increased dampening and may thus ensure that the players are not tired too quickly and may reduce the risk of sprained ankles and knees.

According to embodiments, the artificial turf layer is free of an infill layer. This may be advantageous as installation and maintenance costs may be reduced. It may not be necessary anymore to add an infill layer for providing an artificial turf system having a required minimum degree of elasticity.

According to alternative embodiments, the artificial turf layer comprises an infill layer having a height of less than 1 cm. This may also reduce installation and maintenance costs. It may not be sufficient to add a thin infill layer—e.g., an infill layer of about 0.2-0.4 cm—to provide an artificial turf system with a required minimum degree of elasticity.

According to embodiments, the upper e-layer has a height of 0.8 cm to 4.0 cm, more preferably of 2.5 to 3.0 cm. In addition, or alternatively, the lower e-layer has a height 0.8 cm to 4.0 cm, more preferably of 2.5 to 3.0 cm.

This may be advantageous, as it has been observed that an upper e-layer having a height of at least 0.8 cm, more preferably of 2.5 to 3.0 cm may effectively protect the players from injuries that occur when a player hits the ground just above a node or a rib of the rigid geogrid. A combination of an upper and a lower e-layer each having a height of 2.5 to 3.0 cm may strongly improve the protective effect and may ensure that the geogrid is not damaged by repeatedly hitting and rubbing against a rough surface of the base layer. The use of the lower e-layer, and in particular the combination of the two e-layers, may prolong the life of the geogrid and of the artificial turf structure and may protect the base layer from mechanical wear and tear.

According to embodiments, the elasticity of the upper and lower e-layers and the thickness of the geogrid are adapted to each other such that the lower surface of the upper e-layer and the upper surface of the lower e-layer contact each other except at regions where the ribs of the geogrid separate the upper and the lower e-layer. This may be advantageous, as the geogrid is firmly fixed within the two e-layers even if no adhesive or mechanical fixative is used. Hence, embodiments of the invention may allow installing the artificial turf system comprising the two e-layers and the geogrid very quickly, as it may not be necessary to add an adhesive layer between the lower e-layer and the geogrid or between the geogrid and the upper e-layer in order to firmly fix the geogrid and the two e-layers at a defined, relative position.

For example, the upper e-layer has a height of 2.5 to 3.0 cm, the lower e-layer has a height of 2.5 to 3.0 cm, and the geogrid has a height of 0.1 to 1.0 cm, preferably 0.2 to 0.6 cm.

The geogrid can, for example, form a grid of squares, diamonds, triangles, rectangles, or other polygons. The distance between two adjacent nodes of the geogrid can be, for example, in the range of 0.3-8.0 cm in each dimension. For example, the mesh size of the geogrid can be 12 mm×12 mm, or about 25 mm×25 mm. The more rigid the material of the geogrid, the larger the mesh size may be. Preferably, the distance between two adjacent nodes of the geogrid is in the range of 0.5-5.0 cm in each dimension.

The geogrid can be made of a polymer material, such as polyester, polyvinyl alcohol, nylon, PVC, polyethylene, or polypropylene. The ribs (also referred to as “bars”) of a geogrid may be woven or knitted yarns or heat-welded strips of material, or produced by punching a regular pattern of holes in sheets of material, then stretched into a grid. Preferably, the ribs are not flexible fibers, but rather are stiff ribs.

According to some embodiments, the material of the geogrid is a rigid polymer. The openings between the adjacent sets of longitudinal and transverse ribs, called “apertures,” are large enough to allow for soil strike-through from one side of the geogrid to the other. The ribs of some geogrids are often quite stiff compared to the fibers of geotextiles. Preferably, the junction strength of the geogrid is high. This may ensure that in anchorage situations, the strike-through within the apertures bears against the transverse ribs, which transmits the load to the longitudinal ribs via the junctions. The junctions are regions in the geogrid where the longitudinal and transverse ribs meet and are connected. They are sometimes called “nodes.”

According to some embodiments, the geogrid is a “unitized” (or “homogeneous”) geogrid. This type of geogrid was invented by Dr. Frank Brian Mercer (Mercer, F. B. (1987) “Critical Aspects of Industrial and Academic Collaboration,” The Philips Lecture, The Royal Society).

According to other embodiments, the geogrid is a more flexible, textile-like geogrid using bundles of polyethylene-coated polyester fibers as the reinforcing component. For example, several hundred continuous fibers can be gathered together to form yarns, which are woven into longitudinal and transverse ribs with large open spaces between them. The crossovers are joined by knitting or intertwining before the entire unit is protected by a subsequent coating. Bitumen, latex, or PVC are the usual coating materials.

According to still other embodiments, the geogrid is a geogrid made by laser or by ultrasonically bonding together polyester or polypropylene rods or straps in a gridlike pattern.

According to embodiments, the upper and/or the lower e-layer is made of a mixture of elastic granules and a binder.

For example, the elastic granules can be rubber granules, in particular styrene-butadiene rubber (SBR) granules and/or ethylene propylene diene monomer (EPDM) rubber granules. This may be beneficial, because the elasticity provided by the rubber granules protects the joints of the players from injury. In addition, the increased elasticity of the ground allows the ball to bounce back farther and faster.

According to embodiments, the binder is a polyurethane (PU) binder.

According to embodiments, the mixture further comprises fibers. As a consequence, these fibers become embedded in the e-layer created from said mixture.

Including fibers in the mixture that provides the e-layers may be beneficial because the fibers have a much higher surface-to-mass ratio than, for example, the rubber granules, and hence provide for an e-layer with a higher tensile strength than e-layers merely comprising elastic granules do. The fibers connect different regions of the e-layer with each other and provide for a homogeneous distribution of any impacting force across a large surface area. For example, the force of the impact of a ball or the force of a player's foot during sudden braking or change of direction is distributed by the geogrid and also by the fibers within the e-layer over a comparatively large area. This reduces the wear and tear of the e-layer (and the artificial turf lying on top of it), protects the players from injuries, and improves the movement behavior of the ball.

The protective effect of the fibers is particularly beneficial in temperate climate zones in which many freeze-thaw cycles are observed each year, because these freeze-thaw cycles may create large cracks and holes in the base layer and may result in severe damage of the artificial turf layer if a ball or foot hits the artificial turf where it covers a large hole in the base layer (see above).

According to embodiments, the fibers contained in the mixture (which are hence embedded in the upper and/or lower e-layer created from this mixture) are non-stretchable. This may be beneficial, because non-stretchable fibers provide for an e-layer with particularly high tensile strength. For example, many synthetic fibers, like nylon, are basically non-stretchable at room temperatures.

According to embodiments, the fibers have a random orientation within the binder. This may be beneficial, because the tensile strength of the e-layer is increased in all directions of the e-layer.

According to embodiments, the fibers have a length of at least 1 cm, preferably of at least 2 cm. This may be beneficial, because fibers shorter than 1 cm have been observed to provide only a comparatively low increase in the tensile strength.

According to embodiments, more than 60% of the fibers have a length of 1-5 cm, preferably 3-4 cm.

According to embodiments, the fibers have different lengths. Preferably, the difference between the average (or maximum) length of the shortest 10% of the fibers and the average (or maximum) length of the longest 10% of the fibers is at least 3 cm, preferably at least 4 cm.

This may be advantageous, because the small fibers can be oriented freely and randomly in all directions of the e-layer created from the mixture, including the vertical direction, thereby also increasing the tensile strength in that vertical direction. If only long fibers were added to the mixture used for providing the e-layer, these fibers would be forced to adopt a horizontal orientation—e.g., from left to right or vice versa, or from front to back or vice versa—but not a vertical one, because the height of the e-layer is less than the length of the fiber. The long fibers significantly increase the tensile strength of the e-layer, but may not all be oriented randomly within the e-layer because their length may be greater than the height of the e-layer. Hence, a combination of short and long fibers may be particularly advantageous, as the combination may ensure a random orientation of at least a fraction of the fibers and at the same time a significant increase in the tensile strength of the e-layer, in particular in a horizontal direction.

According to embodiments, the fibers are plant fibers, synthetic fibers, or a mixture of plant fibers and synthetic fibers.

Using plant fibers may be advantageous, as plant fibers are typically cheap and biodegradable. Hence, an environmentally friendly and cheap fiber type may provide for an e-layer whose CO₂ footprint is smaller than that of conventional e-layers for artificial turf.

According to embodiments, the plant fibers are jute fibers, hemp fibers, corn silk fibers, flax fibers, bamboo fibers, kapok fibers, sisal fibers, coconut fibers, cotton fibers, cellulose fibers, or mixtures thereof.

According to embodiments, the synthetic fibers are polyethylene fibers, polyamide fibers, polypropylene fibers, nylon fibers, polyester fibers, glass fibers, fibers made of rubber (e.g. Ethylen-Propylen-Dien (EPDM) rubber, Styrene Butadiene Rubber (SBR)), or mixtures thereof.

According to other embodiments, the fibers are mixtures of plant fibers and synthetic fibers.

According to embodiments, the fibers comprise synthetic fibers comprising a nucleating agent. For example, the nucleating agent can be an inorganic substance such as talcum, kaolin, calcium carbonate, magnesium carbonate, silicate, silicic acid, silicic acid ester, aluminum trihydrate, magnesium hydroxide, meta- and/or polyphosphates, or coal fly ash. According to other examples, the nucleating agent is an organic substance (e.g., 1,2-cyclohexane dicarbonic acid salt, benzoic acid, benzoic acid salt, sorbic acid, or sorbic acid salt). This may be advantageous, because the nucleating agent can increase the surface roughness of synthetic fibers, thereby strengthening the adhesion of the binder to the fiber surface. This may improve the homogeneous spreading of impacting forces over a larger area of the e-layer.

According to embodiments, the synthetic fibers comprise newly produced or used or aged artificial turf fibers or artificial turf fiber fragments. The newly produced artificial turf fibers are preferably production waste (e.g., fibers whose color or profile does not fulfill the requirements of a customer or of the manufacturer). This may be beneficial, as the generated e-layer is more environmentally friendly than state-of-the-art e-layers. This is because production waste generated during the manufacturing of artificial turf fibers can be used to produce the e-layer or because old, worn or aged artificial turf fibers are reused and hence recycled as components of an e-layer.

According to embodiments, the synthetic fibers comprise newly produced or used or worn or aged artificial turf fibers or artificial turf fiber fragments.

In a further aspect, the invention relates to a method for manufacturing an artificial turf system. The method comprises placing a lower e-layer on a base layer, placing a geogrid on the lower e-layer, placing an upper e-layer on the geogrid, and placing artificial turf on the upper e-layer.

According to embodiments, the placing of the lower e-layer is performed by applying a first liquid polyurethane reaction mixture on the base layer and allowing the first reaction mixture to solidify into the lower e-layer. The placing of the upper e-layer is performed by applying a second liquid polyurethane reaction mixture on the geogrid and allowing the second reaction mixture to solidify into the upper e-layer.

The expression “placing or applying something on the geogrid” as used herein covers the regions of the geogrid ribs as well as the regions corresponding to the grid holes formed by the crossing ribs of the geogrid.

According to some embodiments, the artificial turf is applied onto the upper e-layer after the upper e-layer has solidified. This may be advantageous, as the application, fitting, and handling of the artificial turf is facilitated. For example, the workers who carry out the installation of the artificial turf system can walk on the lower e-layer and on the geogrid without restrictions, as the lower e-layer is already cured. In addition, or alternatively, the geogrid is applied onto the lower e-layer after the lower e-layer has solidified. This may be advantageous, as the application, fitting, and handling of the geogrid is facilitated. The workers who carry out the installation of the artificial turf system can walk on the lower e-layer for rolling out and placing the geogrid on top of the lower e-layer, as the lower e-layer is already cured.

In other embodiments, the artificial turf is applied before the upper e-layer has completely solidified. In addition, or alternatively, the geogrid is applied on top of the lower e-layer before the lower e-layer has completely solidified. This may have the advantage that the geogrid is more firmly embedded in between the two e-layers, and relative movement of the geogrid and the not-yet-cured e-layer is prohibited. This is because the liquid PU reaction mixture may incorporate at least portions of the geogrid, thereby ensuring that the geogrid is mechanically fixed when the PU reaction mixture cures.

The upper and/or lower e-layer can be fabricated “in situ”; e.g., by mixing together the components of a liquid PU reaction mixture to be used as the binder (the mixture may optionally comprise elastic granules and/or non-elastic fibers) at the use site a short time (within one hour or less) before the liquid mixture is applied onto the base layer. The liquid mixture has self-leveling capabilities and may optionally be leveled actively with the help of a leveling device.

According to alternative embodiments, the e-layers are fabricated remotely—e.g., at a manufacturing site. For example, the placing of the lower e-layer can be performed by laying a first type of prefabricated elastic tiles on the base layer. The placing of the upper e-layer can be performed by laying a second type of prefabricated elastic tiles on the geogrid. The first and the second types of tiles may be different or may be identical. The tiles can be square-shaped, rectangular, or may have the shape of any other polygon. It is also possible that the upper and/or lower e-layer is fabricated in the form of a lane that is rolled up, transported to the use site, and installed by unrolling the lane at the use site.

In some embodiments, the lower e-layer (consisting, e.g., of a plurality of e-layer lanes or tiles) is glued, tacked, nailed, or otherwise fixed to the base layer. In addition, or alternatively, the upper e-layer (consisting, e.g., of a plurality of e-layer lanes or tiles) is glued, tacked, nailed, or otherwise fixed to the geogrid and the parts of the lower e-layer that are accessible via the holes of the geogrid.

A “binder” or “binding agent” as used herein is a material or substance that holds other materials together mechanically, chemically, or as an adhesive, to form a cohesive whole. For example, the binder can be a polyurethane (PU) reaction mixture—e.g., a one-component or two-component PU reaction mixture. According to some embodiments, the binder further comprises additives and/or elastic granules and/or fibers. The additives can be, for example, pigments, light stabilizers, flame retardants, filler materials such as chalk or sand, and others.

A “geogrid” as used herein is a grid-shaped material adapted to reinforce soils and similar materials. Compared to soil, geogrids are strong in tension. This fact allows a geogrid to transfer forces to a larger area of soil than would otherwise be the case.

A “node” of a geogrid as used herein is a region in the geogrid where the longitudinal and transverse ribs (“bars”) meet and are connected.

A “base layer” can be, for example, soil, sand, concrete, or mixtures thereof. The base layer can likewise be wood or an existing floor pavement. The base layer can be an indoor or outdoor base layer. Typically, the base layer is an outdoor base layer. The term “base layer” does not imply that the base layer has been created manually or with the help of a machine. The base layer can simply be the soil or other form of ground that already exists at the site where the artificial turf system is to be installed. Alternatively, the base layer can be any type of layer that was created manually and/or with the help of a machine and installed on an existing base, e.g., a layer of concrete, wood, stone, or sand.

The term “elasticity” as used herein refers to the ability of a material to recover its original dimensions, and to return to its original shape, after being subjected to a stress. Solid objects will deform when adequate forces are applied to them. If the material is elastic, the object will return to its initial shape and size when these forces are removed.

According to embodiments, the e-layer is adapted for use as a sports ground or playground. According to embodiments, the e-layer has mechanical parameter values, e.g. in respect to shock absorption capacity, rigidity, and/or elasticity, which are adapted for protecting players from injuries when using the floor comprising two e-layers as a sports ground or playground. Preferably, the e-layer has mechanical parameter values which are adapted for protecting players from injuries even in case the sports ground or playground does not comprise any additional elastic layers or an elastic substrate, meaning that the two e-layers are basically the only layer adapted to protect the players from injuries. The sports ground can be, for example, be selected from a group comprising: a baseball ground, a tennis court, a handball ground, a hockey ground, a running track, and a Football ground.

According to embodiments, the e-layer has a shock absorption (measured at 23° C.) of at least 55%, preferably at least 65%. For example, the e-layer has a shock absorption of 55-70%. The shock absorption can be measured in accordance with the testing method detailed in the FIFA Handbook of Tests Methods for Football Turf 2015 (in particular sections 4 and 11).

According to embodiments, the e-layer has a vertical deformation of 4 mm-11 mm as a result of an impact of a 20 kg mass measured at 23° C. in accordance with the testing method detailed in the FIFA Handbook of Tests Methods for Football Turf 2015.

An “e-layer” can be, for example, a layer that has a shock absorption (measured at 23° C.) of at least 55% and a vertical deformation of at least 4 mm, preferably at least 6mm, measured at 23° C. in accordance with the testing method detailed in the FIFA

Handbook of Tests Methods for Football Turf 2015.

According to one embodiment, the “e-layer” is a layer that has a Head Injury Criteria (HIC) of less than 1000. For example, this type of e-layer can be used as a rugby sports floor. According to some embodiments, the e-layer is a layer that has a HIC of less than 200. For example, this type of e-layer can be used as a playground.

The testing for the HIC value of a surface or layer and for the related “critical height” of said surface or layer is typically done in a laboratory, however, testing may also be done in the field using the F1292 testing methodology. The ASTM International (ASTM) Standard F1292 is designed to provide a testing method for surfacing materials that will allow assessment of impact attenuation of playground surfacing and thus reduce the severity and frequency of fall-related head injuries.

The shock or force of the impact of an object on a surface can be measured in “g's” which is the acceleration due to gravity. The maximum peak deceleration before a debilitating head injury might occur is 200 g's. HIC, Head Injury Criteria, measures the time of deceleration. The value of the HIC must be less than 1000 to avoid a life-threatening head injury.

A “critical height” of a surface is a physical property of a surface or layer that is defined as the maximum fall height from which a life-threatening head injury would not be expected to occur”. Fall height is defined as the vertical distance between a designated play surface and the playground surface beneath it. Fall heights of various kinds of play equipment are identified in the U.S. Consumer Product Safety Commission (CPSC) publication “Public Playground Safety Handbook” in Section 5 under each type of equipment. Critical height is determined by a combined measurement of acceleration (shock) of an impact and the duration of the impact as it relates to head injury.

Preferably, the elastic layer is an area-elastic layer. According to one embodiment, the lower elastic layer is a self-leveling, in-situ created layer composed of an elastic granulate, a binder and further substances. The upper elastic layer can be an in-situ created layer or can be manufactured in a factory.

For example, an “elastic layer” or “e-layer” can be a material layer whose main or only function is the provision of elasticity. Preferably, the e-layer consists of a solid, homogeneously distributed elastic substance or substance mixture comprising elastic components. For example, the e-layer can be made of a binder, e.g. a PU binder, comprising homogeneously distributed elastic granules, e.g., rubber granules. The PU binder itself can be elastic also. For example, the PU binder can be a PU foam. A complete artificial turf layer that may optionally comprise a thin elastic sub-layer, e.g., a backing, is not an “elastic layer.” For example, an elastic layer can have a height of 20-35 mm.

A “non-stretchable” material as used herein is a material that does not increase its length significantly if a pulling force of about 50 Newton at about 20° C. is applied. For example, a non-stretchable material can be a material that does not increase its length by more than 5% if a pulling force of about 50 Newton at about 20° C. is applied. Hence, a non-stretchable material is a material that basically does not extend if subjected to this pulling force.

A “nucleating agent” as used herein is a substance that promotes the crystallization of semi-crystalline polymers. These substances function by presenting a heterogeneous surface to the polymer melt, making the crystallization process more thermodynamically favorable. As a result of this effect, the temperature of the polymer melt at which the polymer begins to crystallize is increased, as are the rate of nucleation and overall rate of crystallization.

A “pile height” as used herein is the height of artificial turf fibers measured from the top surface of the carrier to the top of the artificial turf.

It is understood that one or more of the aforementioned embodiments of the invention may be combined as long as the combined embodiments are not mutually exclusive.

The following embodiments of the invention are explained in greater detail, by way of example only, making reference to the following figures:

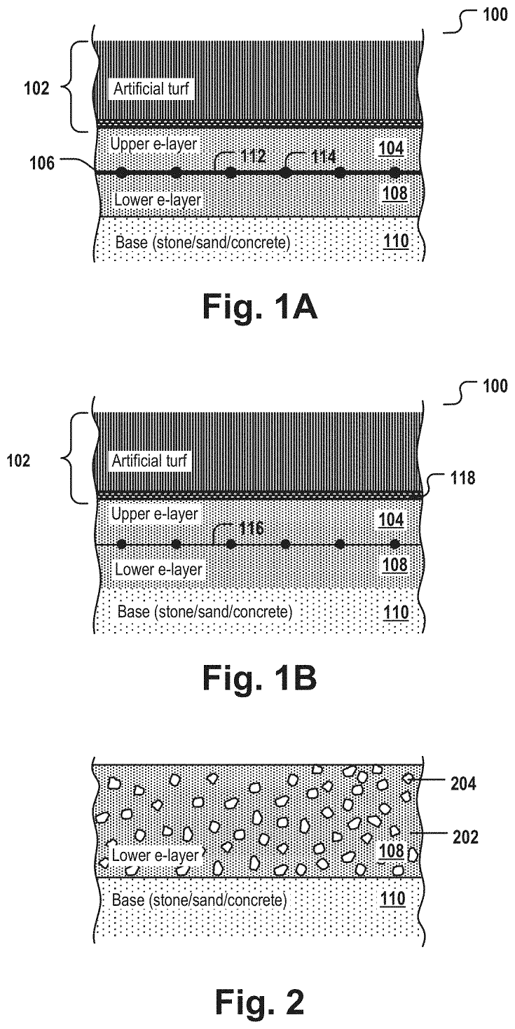

FIG. 1A is a cross-sectional view of an artificial turf system;

FIG. 1B is another cross-sectional view of the artificial turf system depicted in FIG. 1A;

FIG. 2 is a schematic, cross-sectional view of a lower e-layer comprising elastic granules;

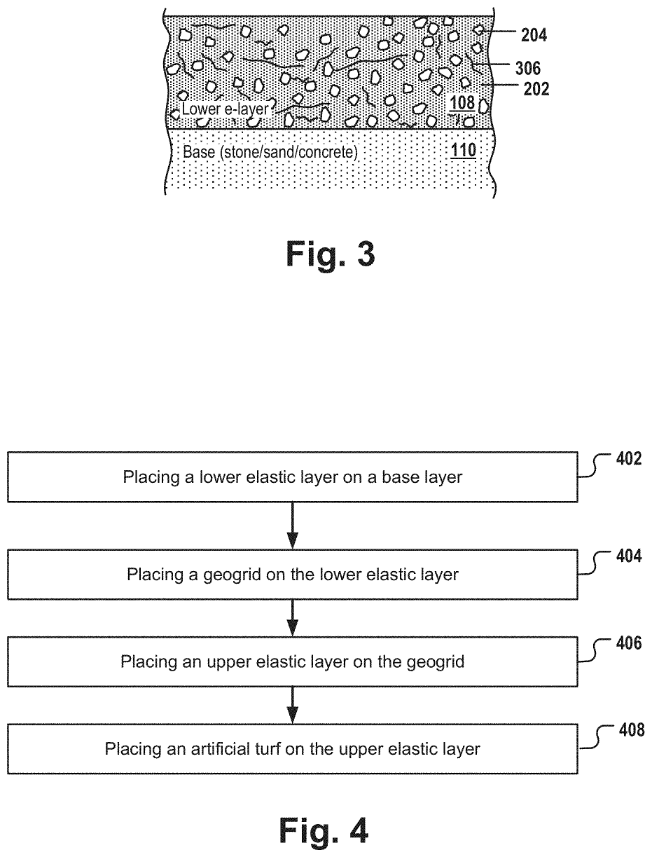

FIG. 3 is a schematic, cross-sectional view of a lower e-layer comprising elastic granules and fibers;

FIG. 4 is a flowchart of a method of producing an artificial turf system;

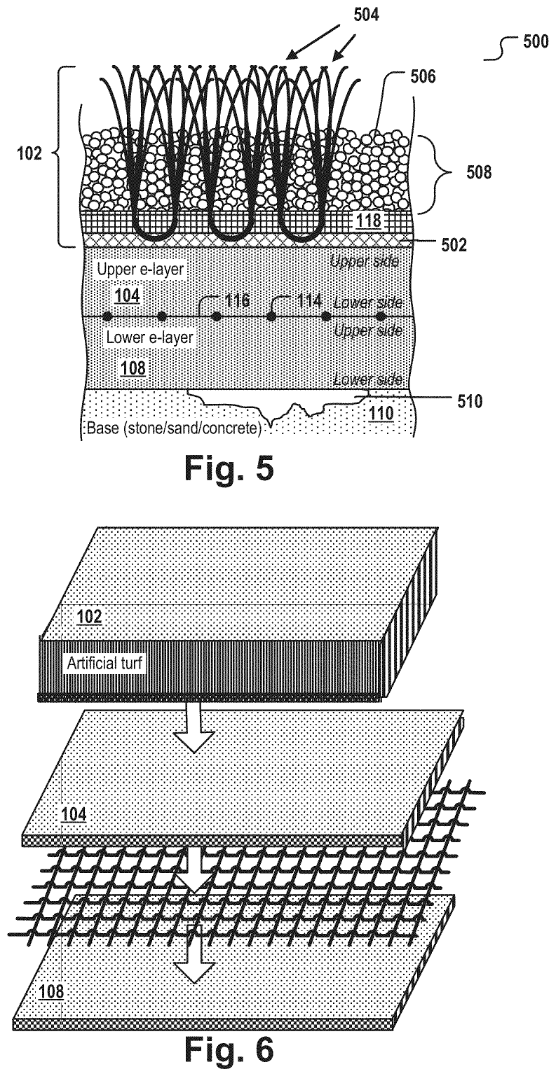

FIG. 5 is a schematic, cross-sectional view of an artificial turf system comprising a fill layer; and

FIG. 6 illustrates the installation of the individual layers of an artificial turf system.

### DETAILED DESCRIPTION

FIG. 1A is a cross-sectional view of an artificial turf system 100. It comprises an artificial turf layer 102, an upper e-layer 104, a geogrid 106, and a lower e-layer 108. The geogrid comprises multiple nodes 114 corresponding to regions where two groups of parallel ribs intersect and are connected to each other. FIG. 1A shows a cross-section of the artificial turf system that was cut along one 112 of the ribs. The artificial turf system 100 is installed on top of a base layer 110. The base layer can be, for example, stone, sand, concrete, wood, or any other type of material or material mixture.

FIG. 1B is another cross-sectional view of the artificial turf system 100 depicted in FIG. 1A that was cut at another position. The cross-sectional view depicts the cross-section of multiple ribs outside of a node region. The thin line 116 illustrates that the lower surface of the upper e-layer 104 and the upper surface of the lower e-layer 108 contact each other, thereby embedding and mechanically fixing the geogrid 106.

FIG. 2 is a schematic, cross-sectional view of a lower e-layer 108 comprising elastic granules 204 that are randomly distributed and embedded in a binder 202, e.g., a solidified PU reaction mixture. The elastic granules can be, for example, rubber granules, such as EPDM or SBR rubber granules.

According to some embodiments, the composition of the upper e-layer 104 (not shown in FIG. 2) is identical to the composition of the lower e-layer depicted in FIG. 2. According to other embodiments, the composition of the lower e-layer is different from the composition of the upper e-layer. For example, the lower e-layer 108 can comprise additional fillers, such as sand and/or chalk, that are absent in the upper e-layer or that are contained to a significantly lesser extent (e.g., at least 10% less by weight, or at least 20% less by weight) in the upper e-layer than in the lower e-layer. The additional fillers may reduce the costs of the material but increase the brittleness of the material, whereby an increased brittleness in the lower layer is more acceptable as already the upper elastic layer may largely absorb the shock of impacting objects.

FIG. 3 is a schematic, cross-sectional view of a lower e-layer 208 that comprises elastic granules 204 and fibers 306. The granules and fibers are randomly distributed and embedded in a binder 202.

FIG. 4 is a flowchart of a method of producing an artificial turf system 100, e.g., an artificial turf system as depicted in FIG. 1 or 5. The method described in the following is graphically illustrated in greater detail in FIG. 6.

First, in step 402, a lower e-layer 108 is placed on a base layer 110. The lower e-layer 108 can be created using an in-situ PU foam generation method as described, for example, in WO2018002203A1, EP3263620A1, or EP3216919A1. Alternatively, prefabricated, elastic PU tiles or lanes can be placed on the base layer 110 for providing the lower e-layer. Optionally, the lower e-layer can be glued, tacked, nailed, or otherwise fixed to the base.

Next, in step 404, a geogrid 106 is placed on the lower e-layer 108. Preferably, this step is performed after the lower e-layer has completely cured. In some embodiments, the geogrid may be applied while the in situ—generated lower e-layer is still liquid, such that some portions of the geogrid, e.g., the lower 2-4 mm of the geogrid, are embedded in the lower e-layer.

Next, in step 406, an upper e-layer 104 is placed on the geogrid. The upper e-layer can be applied, for example, in the form of a liquid PU reaction mass that embeds upper portions of the geogrid and contacts the surface of the lower e-layer where the lower e-layer is not covered by ribs or nodes of the geogrid. This may be advantageous, as the geogrid is fixed in between the two e-layers particularly firmly. This may prevent any relative movement of the geogrid and the e-layers without the need for an extra working step, e.g., without the need for applying an adhesive layer on top of the geogrid and the upper surface of the lower e-layer for ensuring that the geogrid and the upper e-layer do not change their position relative to each other.

Again, the upper e-layer 104 can be created using an in situ PU foam generation method as described, for example, in WO2018002203A1, EP3263620A1, or EP3216919A1.

Alternatively, prefabricated, elastic PU tiles or lanes can be placed on the geogrid for providing the upper e-layer. Optionally, the upper e-layer can be glued, tacked, nailed, or otherwise fixed on top of the geogrid.

Next, in step 408, an artificial turf layer 102 is placed on the upper e-layer. According to some embodiments, the artificial turf layer 102 is applied after the upper e-layer has hardened. If the e-layer is provided in the form of prefabricated tiles or lanes, the e-layer has already hardened at the production site. Applying the artificial turf on top of a hardened upper e-layer may ease the installation process, as the workers can freely walk over the upper e-layer. According to other embodiments, the artificial turf layer 102 is installed before the upper e-layer has completely cured. In this case, the liquid PU reaction mixture that is used for providing the upper e-layer may contact the lower side of the artificial turf layer. According to preferred embodiments, the artificial turf comprises a PU-based backing. This may be advantageous, as the backing and the upper e-layer both consist of urethane and may therefore have similar polarity. This may increase the fixation of the artificial turf layer on top of the upper e-layer.

FIG. 5 is a schematic, cross-sectional view of an artificial turf system 500 according to an exemplary embodiment of the invention. The artificial turf system 500 comprises an artificial turf layer 102 that is installed on top of an upper e-layer 104, a geogrid 106, and a lower e-layer 108, which are also part of the artificial turf system 500 and which have been described already with reference to FIG. 1. The artificial turf layer 102 comprises a plurality of artificial turf fibers 504, which are incorporated in a carrier structure, e.g. a carrier layer 118. The carrier layer can be, for example, a fiber mesh made of synthetic and/or plant-based fibers. The lower side of the carrier can be completely or partially covered by a backing 502, e.g., a latex-based or PU-based backing. The backing 502 incorporates at least some portions of the fibers 504, thereby firmly fixing the fibers in the carrier. The backing 502 is configured to fix a portion of the fibers, and may in addition have a cushioning effect from the forces transmitted and received from above by players or other activities occurring on the artificial turf system 500. In some embodiments, the carrier mesh 118 is formed by interwoven parts of the synthetic artificial turf fibers.

Optionally, the artificial turf layer 102 can comprise an infill layer 508. The infill layer comprises a plurality of infill granules 506, e.g., sand, organic granules, rubber granules, or mixtures thereof. The infill layer provides some extra elasticity. However, as the two e-layers already provide elastic support for the elastic turf, an artificial turf system 100, 500 is preferably free of an infill layer or comprises only a very thin infill layer, e.g., a layer of only 0.5 cm in height. This may reduce installation and maintenance costs, because the infill granules 506 may be blown away or may leave the artificial turf system as a result of the frequent use of the artificial turf system. In addition, it may be difficult or impossible to separate the infill from debris that may accumulate between the fibers over the years. To the contrary, the elastic granules or other elastic elements that constitute or are incorporated in the lower and/or upper e-layer cannot leave the e-layer or intermix with debris. Hence, using the two e-layers instead of an infill layer may reduce maintenance effort and may increase the life of the artificial turf system.

In one embodiment, the artificial turf fibers 504 are arranged in the carrier structure 118—e.g., a textile plane—by means of tufting. Tufting is a type of textile weaving in which an artificial turf fiber (which may be a monofilament or a bundle of multiple monofilaments) is inserted in or through the carrier structure 118. After the inserting is done, some parts of the artificial turf fibers 504, exposed to a lower side of the carrier structure 118, are mechanically fixed by the elastic backing 502. Other parts of the artificial turf fibers 504 are fixed by the carrier structure 118 and still further parts of the artificial turf fibers protrude from the upper surface of the carrier and form the visible artificial turf fibers.

In one embodiment, the backing 502 may be formed by applying an elastic binding agent—e.g., latex or a PU reaction mixture—onto the lower side of the carrier after the fibers are tufted or otherwise integrated into the carrier. The elastic binding agent can be any kind of fluid that is capable of solidifying after a predefined setting (or hardening) time into a solid layer or film. The fluid, also referred to as an elastic binding composition, may solidify into a film or layer by a drying process or by a chemical reaction resulting in a solidification of the fluid into a solid backing. Such a chemical reaction can be, for example, a polymerization.

FIG. 5 shows a large hole 510 in a base layer 110 that may have been created as the result of frequent freeze-thaw cycles. For example, several materials that are commonly used as a base layer, such as concrete or concrete-stone mixtures, may show significant signs of decay after several years of use, in particular in climate zones with frequent freeze-thaw cycles. The applicant has observed that some types of artificial turf layers that are directly installed on top of a base layer 110 may be damaged or even torn apart when a ball or the foot of a player hits the artificial turf layer just above such a hole 510. The absence of the base layer at the point of impact implies that the artificial turf layer has to absorb and withstand the impacting force on its own. This requires a mechanical strength that may not be supported by all types of artificial turf systems, in particular not by cheaper artificial turf variants. Using two e-layers and a geogrid may provide sufficient support to protect cheap, lightweight artificial turf variants from damage caused by objects that hit the artificial turf just above a hole in the base layer. This is because the impact is homogeneously distributed by the geogrid over a large surface area.

Preferably, embodiments of the artificial turf system 100, 500 have drainage holes or other means for providing effective drainage of water. They offer an effective manner of providing for a level playing surface, but also provide for a playing surface that has enough cushion to simulate real grass playing surfaces.

### LIST OF REFERENCE NUMBERS

100 artificial turf system
102 artificial turf layer
104 upper e-layer
106 geogrid
108 lower e-layer
110 base layer
112 rib of geogrid
114 node of geogrid
118 carrier structure
202 binder
204 elastic granules
306 fiber
402-408 steps
500 artificial turf system
502 backing
504 artificial turf fibers
506 infill granules
508 infill layer
510 hole in the base layer

1. An artificial turf system (100, 500) comprising:
an artificial turf layer (102);
an upper elastic layer (104) positioned below the artificial turf layer;
a geogrid (106) positioned between the first elastic layer and a lower elastic layer; and
the lower elastic layer (108) positioned below the geogrid.

2. The artificial turf system according to claim 1, wherein the artificial turf is free of an infill layer (508) or comprises an infill layer (508) having a height of less than 1 cm.

3. The artificial turf system according to claim 1, wherein the upper and/or the lower elastic layer has a height of 0.8 cm to 4.0 cm, more preferably 2.5 to 3.0 cm.

4. The artificial turf system according to claim 1, wherein the elasticity of the upper and the lower elastic layers and the thickness of the geogrid are adapted to each other such that the lower surface of the upper elastic layer (104) and the upper surface of the lower elastic layer (108) contact each other except at regions where the ribs (112, 114) of the geogrid separate the upper and the lower elastic layer.

5. The artificial turf system according to claim 1, wherein the upper and/or the lower elastic layer is made of a mixture of elastic granules (204) and a binder (202).

6. The artificial turf system according to claim 5, the binder being a polyurethane binder.

7. The artificial turf system according to claim 5, the mixture further comprising fibers (302).

8. The artificial turf system of claim 7, wherein the fibers are non-stretchable.

9. The artificial turf system of claim 7, wherein the fibers have a random orientation within the binder.

10. The artificial turf system of claim 7, wherein the fibers have a length of at least 1 cm, preferably of at least 2 cm.

11. The artificial turf system of claim 7, wherein more than 60% of the fibers have a length of 1-5 cm, preferably 3-4 cm.

12. The artificial turf system of claim 7, wherein the fibers have different lengths and wherein, preferably, the difference between the length of the shortest 10% of the fibers and the length of the longest 10% of the fibers is at least 3 cm, preferably at least 4 cm.

13. The artificial turf system of claim 7, wherein the fibers are plant fibers, synthetic fibers, or a mixture of plant fibers and synthetic fibers.

14. The artificial turf system of claim 7, the fibers being selected from the group consisting of jute fibers, hemp fibers, corn silk fibers, flax fibers, bamboo fibers, kapok fibers, sisal fibers, coconut fibers, cotton fibers, cellulose fibers, polyethylene fibers, polyamide fibers, polypropylene fibers, nylon fibers, polyester fibers, glass fibers, fibers made of rubber, fibers made of Ethylen-Propylen-Dien (EPDM) rubber, Styrene Butadiene Rubber (SBR)) and mixtures thereof.

15. The artificial turf system of claim 7, the fibers comprising synthetic fibers comprising a nucleating agent.

16. The artificial turf system of claim 15, the nucleating agent being be an inorganic substance selected from the group consisting of talcum, kaolin, calcium carbonate, magnesium carbonate, silicate, silicic acid, silicic acid ester, aluminum trihydrate, magnesium hydroxide, meta- and/or polyphosphates, and coal fly ash.

17. The artificial turf system of claim 15, the nucleating agent being an organic substance selected from the group consisting of 1,2-cyclohexane dicarbonic acid salt, benzoic acid, benzoic acid salt, sorbic acid, and sorbic acid salt.

18. A method for manufacturing an artificial turf system (100, 500) comprising:
placing (402) a lower elastic layer (108) on a base layer (110);
placing (404) a geogrid (106) on the lower elastic layer (108);
placing (406) an upper elastic layer (104) on the geogrid; and
placing (408) an artificial turf (102) on the upper elastic layer.

19. The method of claim 18,
wherein the placing of the lower elastic layer is performed by applying a first liquid polyurethane reaction mixture on the base layer and allowing the first reaction mixture to solidify into the lower elastic layer; and
wherein the placing of the upper elastic layer is performed by applying a second liquid polyurethane reaction mixture on the geogrid and allowing the second reaction mixture to solidify into the upper elastic layer.

20. The method of claim 18,
wherein the placing of the lower elastic layer is performed by laying first prefabricated elastic tiles on the base layer;
wherein the placing of the upper elastic layer is performed by laying second prefabricated elastic tiles on the geogrid.
